(19) United States
(12) Patent Application Publication
(10) Pub. No.: US 2005/0125282 A1
(43) Pub. Date: Jun. 9, 2005

(54) Juror research

(76) Inventor: Adam Rosen, Somerville, MA (US)

Correspondence Address: FISH & RICHARDSON PC, 225 FRANKLIN ST, BOSTON, MA, 02110, US

(21) Appl. No.: 11/031,510

(22) Filed: Jan. 7, 2005

Related U.S. Application Data
(63) Continuation of application No. 09/909,410, filed on Jul. 19, 2001, now abandoned.

(51) Int. Cl. G09B 19/00; G06F 17/60

(52) U.S. Cl. 705/11; 434/219

(57) ABSTRACT

A system features (a) enabling electronic posting of a performance that expresses a position of a party on an issue, (b) storing the posted performance digitally, (c) enabling at least two different individuals at two different locations to observe at least portions of the performance, and (d) enabling each of the individuals to post electronically feedback relating to the persuasiveness of the performance of the party with respect to the issue.

This application is a continuation of and claims the benefit of priority from U.S. application Ser. No. 09/909,410, filed Jul. 19, 2001, and the disclosure of the prior application is considered part of and is incorporated by reference in its entirety in the disclosure of this application.

### BACKGROUND

This invention relates to juror research.

Thirty million lawsuits and criminal cases are filed annually in the United States. Each case in which a jury is required or has been requested is resolved either directly through a jury trial or in part based on expectations as to how a jury would react to the case. These resolutions include pre-trial settlements, waiver of the right to jury trial, plea-bargains, arbitrations and mediations.

Because of the value of anticipating jury reaction to a case in making important case decisions, the tool of “mock-trials” has proliferated in the last fifteen to twenty years. In this exercise, a group of citizens are collected at a research facility or conference center and presented a semblance of the case arguments, evidence and/or witnesses and views are solicited through questionnaires and group discussions or deliberations.

The business of predicting or anticipating jury reaction through this method has become a multi-million dollar industry in the last few years, even though the current cost and complexity of conducting such research makes it cost-justified in only the largest cases. Although most lawyers desire this type of information before trial, under the current cost-structure for these studies, the lawyers cannot usually justify the time and expense in cases involving less than several million dollars in value. More recently, attempts to conduct this research more cost-effectively on the Internet have begun to proliferate.

Some existing on-line jury research services distribute written summaries on-line to jurors and get their feedback. Another format uses online chat rooms in which jurors respond to text based focus group-like discussions on case facts led by a conference moderator.

Another approach uses live online conferencing technology in which all jurors can hear arguments while simultaneously being led through a series of exhibits. The jurors hear a more realistic rendering of the case argument than if it were just written. To have all jurors on-line simultaneously, however, requires a substantial degree of planning and scheduling by attorneys, clients, the administrator of the project, and by jurors and thus represents an ongoing expense, convenience and time barrier to usage of this tool in most cases.

### SUMMARY

In general, in one aspect, the invention features (a) enabling electronic posting of a performance that expresses a position of a party on an issue, (b) storing the posted performance digitally, (c) enabling at least two different individuals at two different locations to observe at least portions of the performance, and (d) enabling each of the individuals to post electronically feedback relating to the persuasiveness of the performance of the party with respect to the issue.

Implementations of the invention may include one or more of the following features. The position on the issue comprises a legal argument related to a litigation issue. The performance includes audio material and graphic material. At least part of the performance is posted from a telephone or mobile telephone. The two different individuals observe the performance at two different times. The performance is delivered as streaming digital information to the individuals. The feedback is posted in the form of email or responses given through a website. The electronic posting of the performance includes uploading graphical information and posting of timing information useful in synchronizing audio material and graphical material. The feedback from the individuals is analyzed. The individuals are jurors. The individuals are drawn from designated groups.

Other advantages and features of the invention will become apparent from the following description and from the claims.

### DESCRIPTION

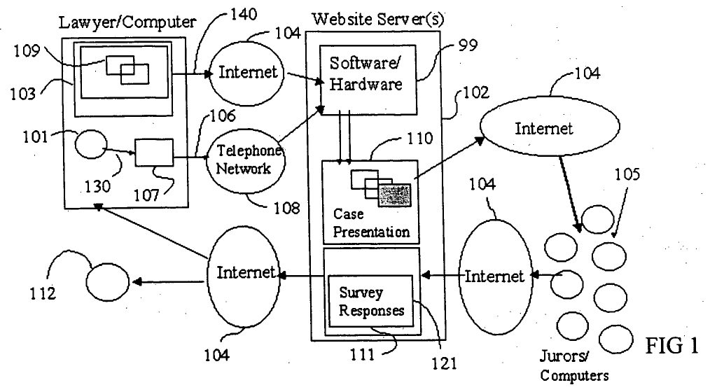

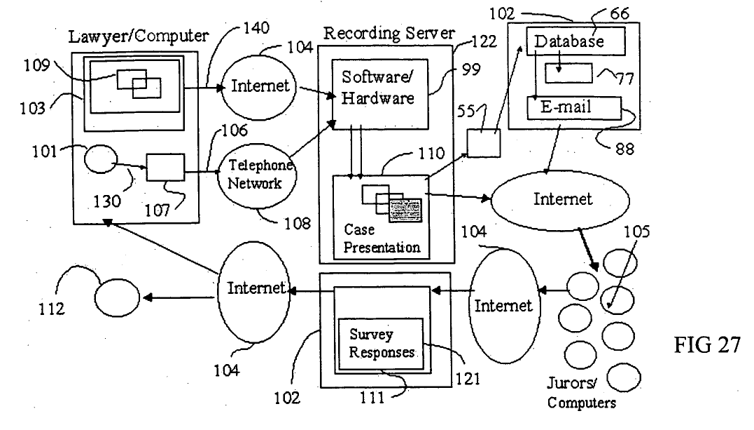

(FIGS. 1 and 27 are block diagrams of system architectures.

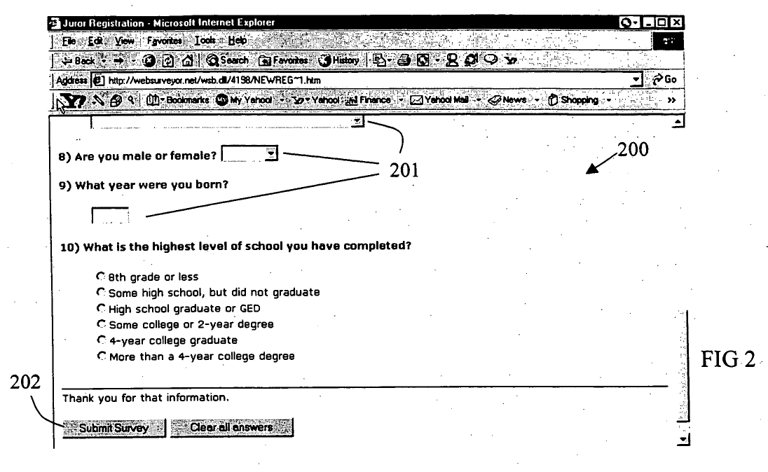

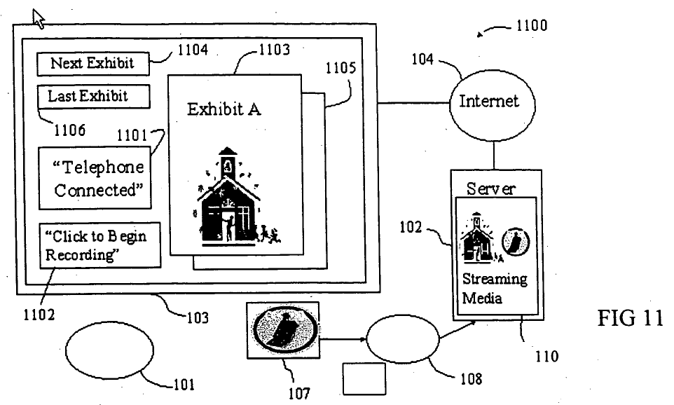

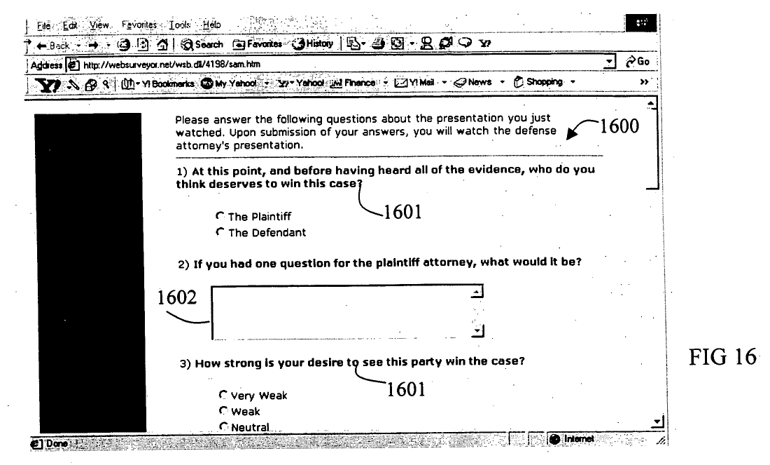

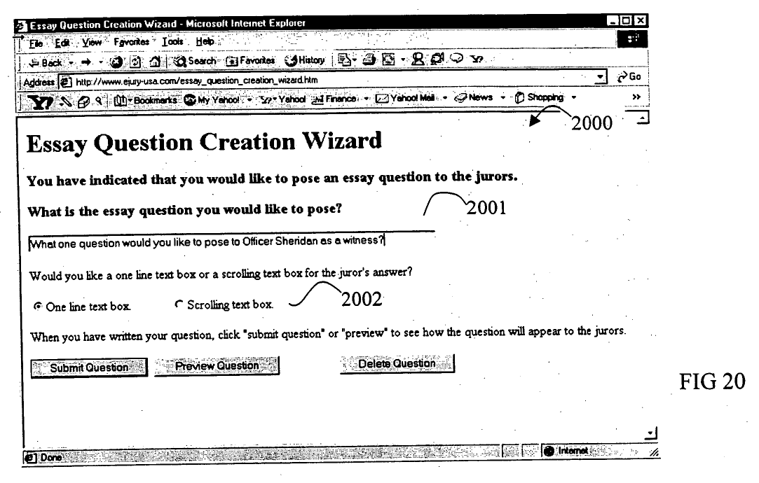

FIGS. 2 through 7, 11, 13, and 15 through 26 are screen shots of web pages.

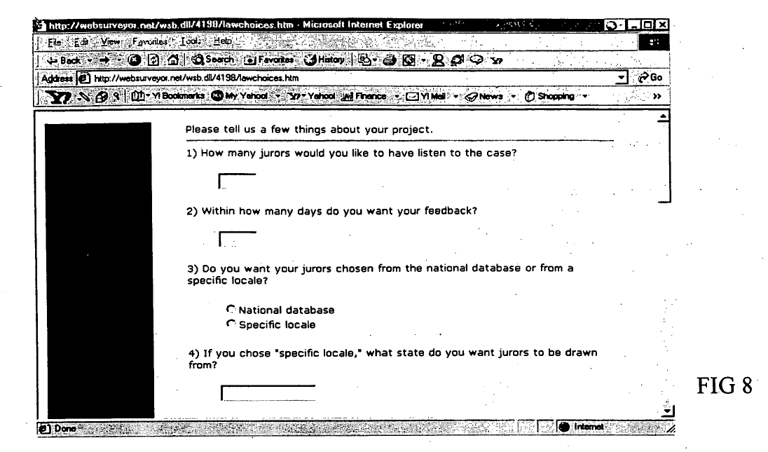

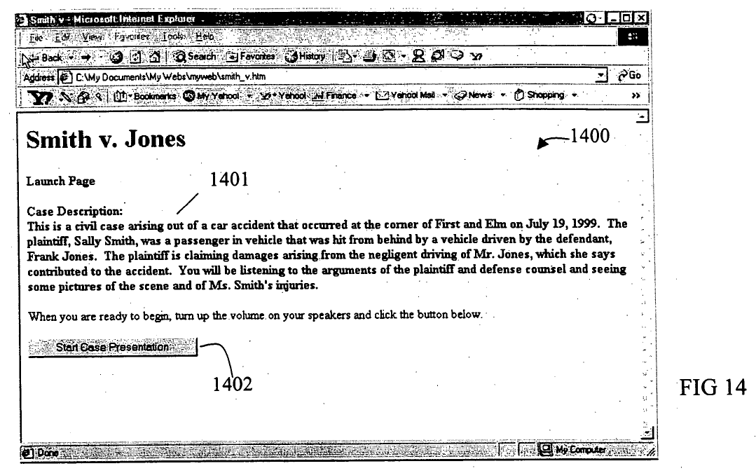

FIGS. 8 through 10, 12, and 14 are block diagrams.)

As shown in FIG. 1, an inexpensive, easy-to-use Internet-based jury research system 1 enables a trial attorney 101 to log-on to a website 102 through his computer 103 and the Internet 104 and to select any number of registered individuals 105 to act as mock jurors. The mock jurors have agreed in advance to provide this service for a fee and have been organized for that purpose by the operator of the website 102 through prior solicitation and sign-up processes. Due to the global nature of the Internet, the attorneys and the mock jurors may be located anywhere.

After selecting mock jurors, an attorney 101 records his or her argument 130 in the form of an audio signal 106 using telephone or mobile phone 107 through the public telephone or mobile phone network 108 and may also upload through the Internet 107 graphic material such as pictures, diagrams or slides 109 that illustrate key issues or evidence. The graphic material may be uploaded onto a website server 102 before he records his arguments, so that when the attorney speaks his argument 130 into the telephone or mobile telephone 107, he can simultaneously click on his computer screen 103 to control, by Internet communication with the server 102, which visual exhibit will appear to jurors during each part of his statement 130. The ability to specify a document that is to appear at a given time with respect to audio material is available, for example, on Raindance.com.

Software 99 running on the server records and stores the audio signal 106 of his argument 130, the uploaded visual exhibits 109 that appeared during each portion of the argument, and the timing information 140 that was specified by the attorney to indicate which visuals should be presented during each portion of the argument 130. These three sets of data/information (e.g. audio, visual, and timing information) are then combined by the software 99 into a single software presentation file in the form of a visual/audio streaming media file 110 which uses the stored audio, visual, and timing information to replicate the visual and audio presentation the lawyer entered into the system. This streaming media presentation 110 is stored on the server. At any later time, each juror can be e-mailed a link or web address which, when invoked, causes the presentation to be streamed over the Internet and played to the jurors 105 on their computers and speakers.

As shown in FIG. 27, one good alternative way to implement the storage and media file creation functions described above is by an outsourcing agreement with a vendor that specializes in this technology, for example, Raindance.com. In this implementation, the server 122 of the vendors receives the audio signal 106, the visual exhibits 109, and the timing information, stores them, creates the streaming media file 110, and transfer a web address link 55 to this file to a database 66 on the jury research site 102. The jury research service site then embeds this web address on a web page 77. A link to this page is then sent to the jurors using e-mail 88. In this example, only the recording, uploading, conversion and storage functions are performed by the vendor. Other functions, such as juror recruitment, registration, polling and feedback, are performed on the primary jury research site server 102, as explained in more detail below.

References here to “recording” arguments on the server or “uploading” exhibits to the server, for example, are meant to include a wide variety of possible implementations, including those in which the uploading or recording are done at the primary server 102 (as in FIG. 1) or at the vendor's server (as in FIG. 27) or in other suitable ways not shown in either figure.

At times convenient to them, each juror 105 views and/or listens to the streaming media case presentation 110. Each juror provides feedback through electronic polling software 121 that gathers survey responses 111 on the web server 102. The polling software automatically generates general analyses such as verdict preferences and more detailed correlations of case reactions and demographics. Attorneys 101 and clients 112 receive web-site based feedback of juror survey responses 111 to their case, including verdict choice percentages and attitudes about the parties and witnesses. A premium level of service includes the scheduling of live juror deliberations through more traditional teleconferencing capabilities, which is not the subject of this patent.

The juror research is used by attorneys and litigation managers to make better settle-versus-trial decisions, trial strategy decisions, witness preparation decisions and evidence clarification research. Insurance companies and corporate legal departments can use the tool to reduce the guesswork for predicting jury reaction to important cases.

The jurors 105 comprise a nationwide group of individuals who have agreed to evaluate cases for a fee. Jurors will be attracted to participate using nationwide advertising and targeted incentive marketing partners.

The simple-to-use technology of FIGS. 1 and 27 permits attorneys to record arguments over a telephone or mobile telephone without complicated computer microphones or cameras. The simple-to-use Internet-based opinion polling software permits juror views 111 to be collected quickly and efficiently and fed back to lawyers 101 and clients 112 instantaneously through a web-page-based presentation of survey results. Thus, for example, the lawyer could dictate the oral argument from a mobile phone in an airport in one city and pick up the juror survey results through a web-enabled personal digital assistant or computer upon arrival at a destination city.

An example of software that performs collection and analysis of juror feedback is Websurveyor, version 3.01, available from Websurveyor Corporation at www.websurveyor.com. Analysis could also be performed using Microsoft Excel scripts.

The service can be provided at low cost and therefore may be used in the majority of cases filed in the United States. The recorded telephone argument provides a strong semblance of the oral power of argument that is important in jury trials. Jurors are enabled to react to the arguments themselves, expressed in the way they would be expressed to a jury, rather than to a written expression of the case arguments. The display of visual exhibits 109 duplicates the timing of how the attorney displayed exhibits during his recording and therefore provides an accurate analog to the presentation that would occur before a real jury in a real trial.

Jurors do not have to be online at the time the attorney presents his argument and not all jurors have to be online at the same time. Counsel can record his argument on a whim, any time of the day or night, without requiring the assistance of a project administrator. Attorneys can set the specifications of their jury pool on the web site interface and then record their argument using a telephone or mobile phone to dial into a toll-free number, which will convert their voice into a streaming media file 110 and will also record which exhibits the attorney displayed on the computer screen during each segment of his oral presentation. This becomes a combined audio/visual streaming media presentation and that file is then stored on the site servers and links to the file embedded in a page to which jurors are directed by an e-mail notification. Jurors can see and/or hear the case presentations individually at any time of day or night.

In some implementations, two attorneys would present the respective opposing sides of a case and jurors would give a verdict preference and other viewpoints on the case after each presentation. Attorneys may also choose to present only one side of the case and solicit general or specific views of jurors to his arguments and evidence.

Attorneys can re-record their arguments if they do not feel that retest the same argument separately in multiple venues, because the case is recorded, and the link can be e-mailed to jurors anywhere. Jurors can listen to arguments at any time of day or night (asynchronous communication), as there is no requirement for simultaneous log-on or viewing. In some implementations, jurors can be permitted to listen to key parts of the case over again if something was difficult to understand, although an attorney may choose to disable this option if he feels it is important to have jurors hear the case only once.

The primary revenue model for the provision of the jury research service is fees charged to attorneys, corporate legal departments, and insurance companies. Additional revenue will be generated from a variety of marketing arrangements in which the pool of potentially several million mock jurors purchase products and services from partner businesses.

We now turn to a more detailed description of the components of this online jury research service, including: registration for jurors, registration of attorneys, corporations and results viewers, juror selection for participation in a case, determination of case specifications, attorney preparation of case, including transferring of exhibits to server and recording of case over a telephone or mobile telephone, juror notification, juror viewing/listening to case presentations, juror polling, polling results tabulation and results display, billing, and other forms of revenue such as advertising on a website.

Juror Registration

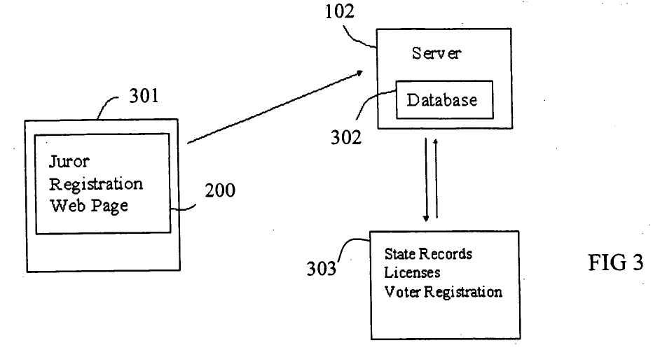

Jurors register by entering information about themselves into a web “form-page,” 200, a sample screen shot of a portion of which is shown in FIG. 2. A full list of information requested from prospective jurors is contained in Appendix A. After entering this information into the specified fields, jurors click a “submit” button 202 on the webpage 200, which sends the registration information through the Internet 104 to the web server 102, where it is stored in a registration database 302 (FIGS. 1 and 3) for later use. After submission of juror registration information from the juror registration page 200, this information may be checked against state driver records and/or juror registration records 303 to confirm identity and age of majority (FIG. 3).

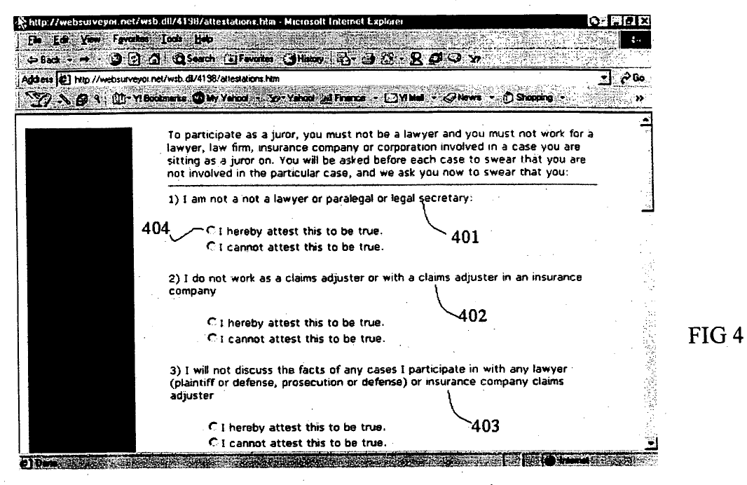

As shown in FIG. 4, in addition to providing information to be used for statistical and juror selection purposes, jurors also review a list of requirements for participation. They are asked to attest to the fact that they (a) are not a plaintiff or defense lawyer or legal secretary 401, (b) are not an insurance company claims representative 402 and (c) will not share information from the case with anyone in either of these roles 403. Additional attestations not shown in the diagram include that they will not distribute their username and password to others and that they are not participating in the service for the purpose of gathering information to be used in any form of legal case. Jurors will “attest to” the truthfulness of these statements by clicking appropriate buttons 404 on their screen and submitting this information. They receive an e-mail confirmation of their statements in this regard, which is also stored on the system servers.

Attorney Registration

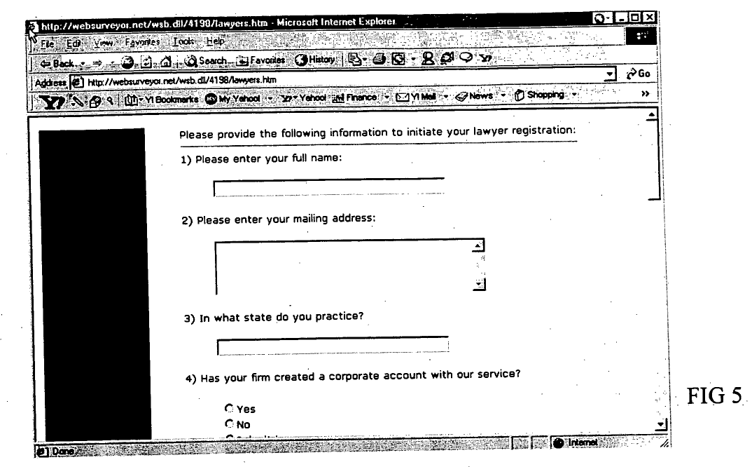

The mechanics of attorney registration are similar to those of juror registration, but differ in some important respects. Attorneys are not required to provide detailed demographic information about themselves (FIG. 5). They are asked simply to specify their area of specialty and to provide their name, business address, billing information (e.g. credit card, electronic payment address or firm account number), as well as their attorney registration number in their state. Upon confirmation of billing information and/or attorney registration, attorneys will be issued an identification number and password which will be used to enter the site, record arguments and access results and billing information.

Attorneys will enter this information in form pages such as the one shown in FIG. 5, similar to juror information pages. This information, upon submission, is sent to and stored on site server 102. When attorneys later come to the site to record a case or review results, they are asked to affirm that they are the attorney they purport to be, as well as providing the private password they were issued. Once they have entered this information, they are taken to a listing of the active case or cases they have on the server.

Client-Viewer Registration

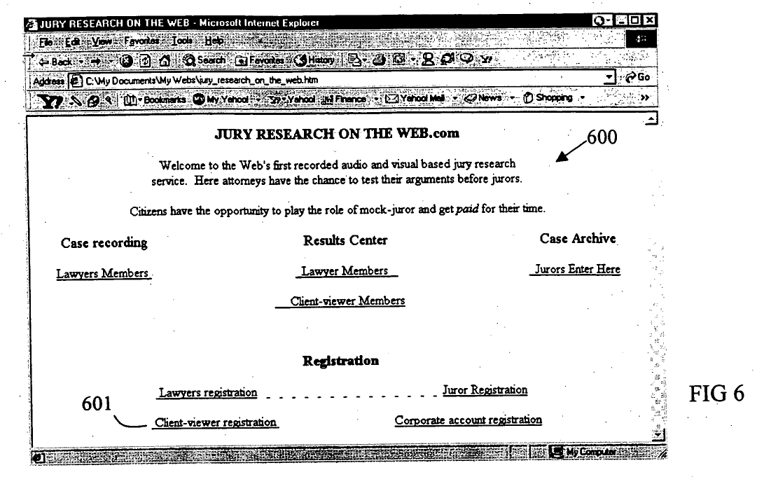

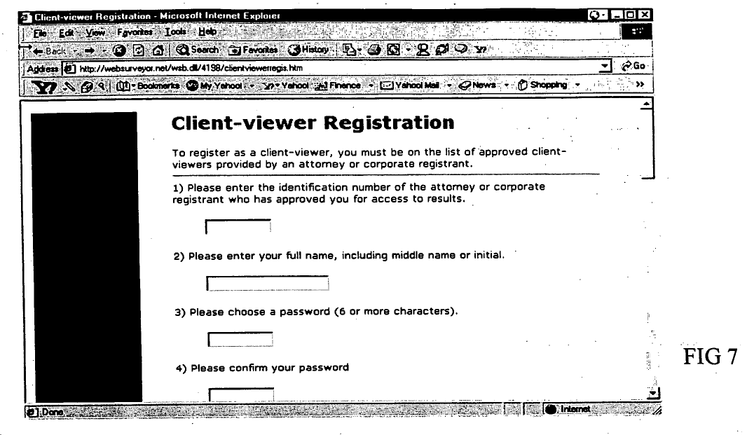

Additional parties who may wish to listen to arguments and view results may include the clients of attorneys or colleagues who may be consulting on the case. This requires registration of “client-viewers.” Each attorney and/or corporate client will have the opportunity of providing a list of “client-viewers” who may register to view the results. As seen in FIG. 6, there is a link 601 on the homepage 600 leading to a client-viewer registration page (FIG. 7). Upon entering the requested information, this information will be sent to the site server. The identity and specific identifying information is then e-mailed to the client or corporate account manager, informing him that a specified individual has requested “viewing rights.” This attorney or corporate account manager will then have the option of coming to the site and approving the rights of this requested user or not. If rights are denied, the username and password for this client-viewer will not be valid and will not provide access to the case arguments or polling results.

Corporate Registration

Corporations or law-firms may seek to register their corporation and provide access to some or all of its personnel. Corporate representatives may provide corporate identification information and billing information. They are assigned company identification numbers as well as identification numbers for each of its personnel whom they wish to authorize as system users.

Selection of Jurors for Case Viewing by Attorneys

Attorneys have the option of selecting jurors randomly from the overall nationwide database or to select specific locations or jurors outside of the venue of the trial for security purposes. Alternatively, attorneys may want to choose jurors from the locale of the trial in order to learn how people from that area view the case.

Attorneys will be asked on a web page, FIG. 8, to specify whether they prefer jurors selected randomly from the nationwide database or if they prefer to select jurors from a specific location. If attorneys select a specific location, they will be provided a list of states to choose from. Once they select a state, they will be provided a list of counties or federal districts to choose from.

Once attorneys have selected a location, the registration database will be queried to determine if enough jurors are available from that location. If there are, these jurors will serve as the sample.

Attorneys will have the opportunity to review the demographic information of these individuals, but not the personal identities of the jurors. If an attorney would like to replace one of the jurors for any reason, he will be given the option to do that.

If there are not enough jurors in the database from the specific locale the attorney has selected, he will have the option of supplementing the group with jurors from another locale or from the nation-wide database.

Determining Case Specifications

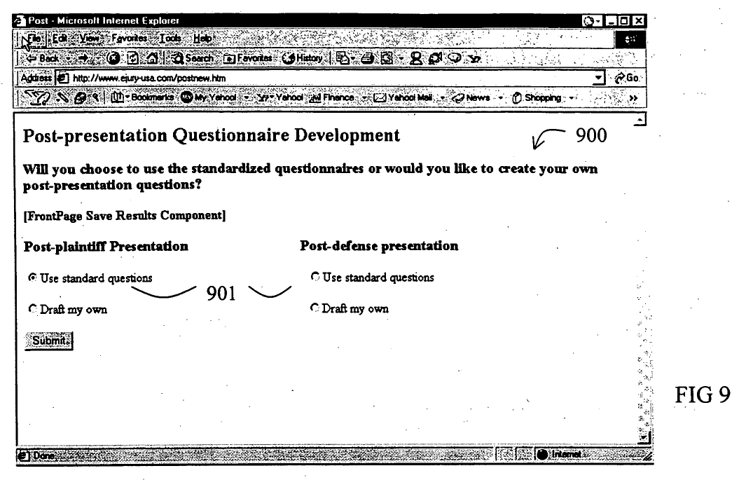

Attorneys may have cases of varying complexity. Accordingly, they will have the options to choose case presentations with various features, including: (a) presentations of varying lengths, (b) presentations with or without visual exhibits, (c) varying numbers of jurors, depending on their goals and budget, (d) They also have the option of choosing a group of generic standardized juror polling questions or creating their own by clicking on the corresponding choices 901 on a web-page 900 (FIG. 9).

Transferring Exhibits to the Server

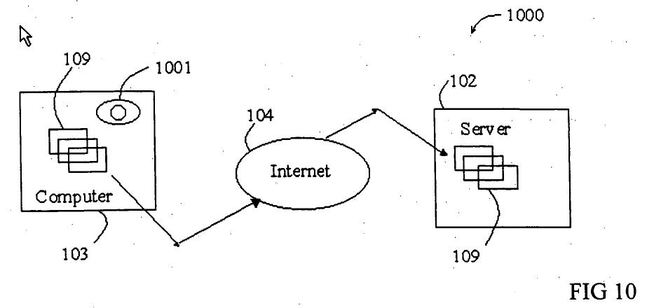

Attorneys may wish to utilize visual exhibits during their case argument/presentation. In order to have these exhibits available during their presentation, attorneys are given the option of clicking an “upload exhibits” button 1001 on the web interface, as seen in FIG. 10. Clicking on this button permits the attorney to locate a file of visual exhibits 109 on his computer 103 and upload it over the Internet 104 to the server (the main server 102 in the case of FIG. 1 or the vendor's server 122 in the case of FIG. 27) for storage, viewing and use during argument recording. Once this file is stored on the server, it is available to the attorney to utilize while recording his spoken argument. In the case of FIG. 27, the jury research site redirects the upload of exhibits to the vendor's server, though in a seamless manner that is not detectible by users, through a branding arrangement in which the jury research service's branding is embedded in the technological user interface of the vendor's software.

Recording of Arguments

By Telephone or Mobile Telephone and Using Web Interface

Once the attorney has stored his exhibits 109 on the server, the site provides him with a telephone number to call with his telephone or mobile telephone 107 over the public switch or mobile telephone network 108. When he calls this number on his telephone or mobile telephone 107 and punches in his identification number, the telephone system signals the server 102 that he is connected and the server prompts him with a notification that the telephone connection has been established 1101 on his computer screen 103, and that he may begin speaking and recording by pressing the appropriate button 1102.

With the first exhibit 1103 of his uploaded exhibits on his screen 103, he clicks the “record” button 1102 and begins speaking. There is a screen control 1104, which permits him to switch to the next visual exhibit 1105 at the appropriate time as well as a control 1106 that permits him to move to previous exhibits.

While the attorney speaks, the server 102 or 122 records both the audio signal of his voice and stores each exhibit that appears during each part. The flow of speech and the interspersion of visual exhibits is recorded by the server software and hardware as mentioned earlier, and a streaming media file 110 is created with the identical sequence of voice and visuals that is presented by the attorney during his presentation.

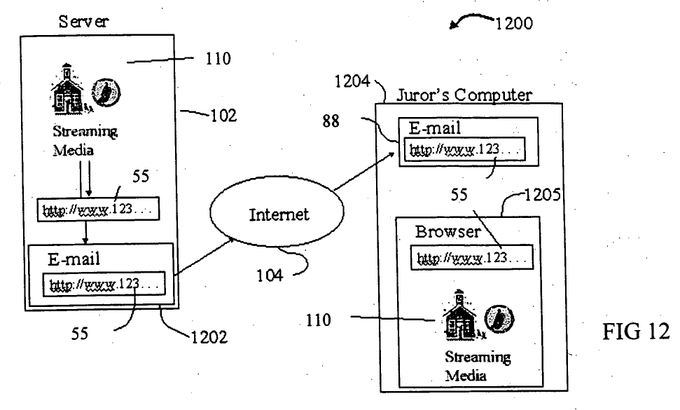

As shown in FIG. 12, after the recording and storing of the streaming media file 110 on the server 102 or 122, the server generates a world wide web URL address 55, which references the streaming media file 110 and stores this for distribution to the selected jurors. The server 102 also automatically drafts a notification e-mail 1202 containing a link to a page in which this URL is embedded. This e-mail is sent to jurors. When this e-mail is opened on the jurors' computer 1204, the juror clicks on the URL or enters it into his browser software 1205, thereby transferring to the web page on which he clicks a button, causing the streaming media presentation 110 to be played on his computer.

In the implementation of FIG. 27, this sequence is effectuated by the vendor's server, which converts the telephonic signal and visual exhibits into streaming media and generates a URL code. The vendor's server 122 automatically submits the URL to a database at the main server 102, from which the server collects it and connects it to the “start case presentation” button on the case “launch” page 77.

Recording By Telephone or Mobile Telephone Without Using a Web Interface.

Traveling attorneys may also want to record an argument without using the web interface and without using visual exhibits. Attorneys will also have the option of calling a toll-free number and recording their arguments without first logging on to a web site. These attorneys will navigate through a series of telephone menus in which they select the location of the jurors from whom they want feedback. For these attorneys, their argument may not have accompanying visual exhibits, but will consist entirely of their spoken argument, converted into streaming audio by the server 102 or 122 at the recording service. The service will provide a case number to these attorneys to be used for accessing polling results at a later time through the web interface and a “results center.”

Notification of Jurors

As soon as attorneys have recorded their arguments and selected juror locations or chosen to not specify juror locations, the system automatically searches the juror database for jurors who meet the location and/or demographic qualifications specified by the attorney or searches the database randomly if no locale specifications have been made.

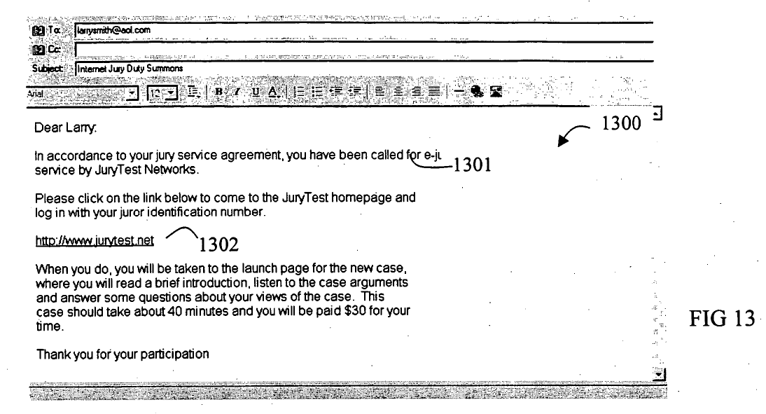

Once the chosen number of jurors are identified in the database, the system software will generate an e-mail notification 1300 (FIG. 13) for each of these jurors. As shown in FIG. 13, the e-mail notification will consist of an e-mail message 1300 from the service which states that the juror in question has been selected for jury service in accordance with the terms of his service agreement 1301. The juror will be asked in the e-mail to use the link 1302 or URL 1302 to come to the service homepage 600 and to log in using his username and password. Once the juror logs in, a “launch” page 77 for the case he has been called for will come up, consisting of a brief introductory paragraph 1401 and a button 1402 which is linked to the URL 55 of the recorded and stored streaming media case presentation 110. Jurors are informed that participation will be on a first come/first served basis. As soon as the quota of jurors requested by the attorney has been filled, subsequent jurors will be informed that their participation will not be needed on this case and that they will be re-entered into the eligibility pool for future cases. Under-recruitment results in subsequent notification of additional jurors.

Viewing and/or Listening to the Case by Jurors.

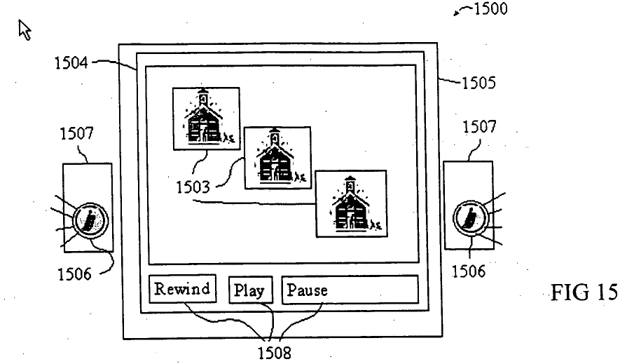

The link to the streaming media file 110 on the server 102 or 122 causes a streaming media player interface 1501, as seen in FIG. 15, to appear on the juror's computer screen 103. This software causes a visual rendering 1503 of the visual exhibit(s) 1103,1105 used in recording the presentation to be played within the streaming media software 1504 on the juror's computer screen 1505 and the corresponding audio 1506 to play on the juror's computer speakers 1507. Jurors watch and/or listen for the duration of the presentation and will also have the opportunity to pause, back-up and play/re-play the presentation by clicking on controls 1508.

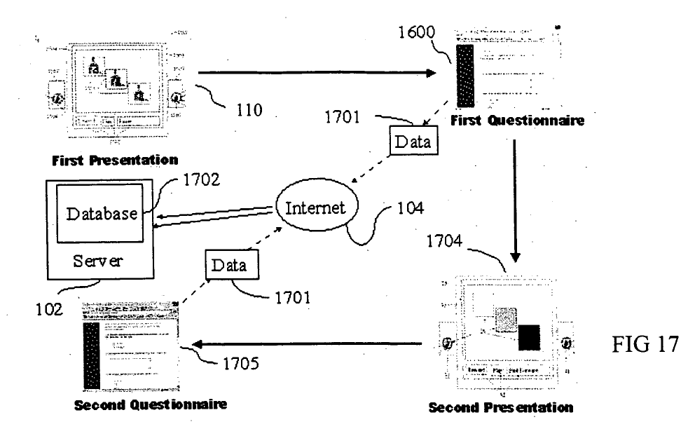

Upon completion of the streaming media presentation, the service will link to another web page 1600 on which a series of multiple choice 1601 and essay-type questions 1602 appear. Jurors will be instructed by text instructions to type in and or click in their answers to these questions and then submit their responses. As seen in FIG. 17, upon submission of these responses, the data 1701 will be transferred to a survey response database 1702 on the main server 102 through the Internet 104.

The juror's computer is then linked to another streaming media player page, where he will hear/see the argument and evidence of the opposing argument, also consisting of a streaming media presentation 110, recorded and synchronized earlier and consisting of the uploaded visuals 109 and audio entered via telephone or mobile telephone. Upon completion of the opposing argument, jurors will again be linked to another polling page with questions and will submit their answers just as they did after the first argument. If there are more than two parties to a case e.g. where there are more than one defendant, there will possibly be a third or fourth argument that jurors will listen to through the linking, presentation and polling process described in this section. The sequence of presentation, polling, presentation, and polling, together with the submission of data to the database on the site server through the Internet is depicted in FIG. 17. Jurors first watch the initial presentation 110, followed by the first set of polling questions 1600. When these are submitted by the juror, the data 1701 is sent to the database 1702 on the server 102 and automatically proceeds to show the next case presentation 1704. That presentation is followed by a second set of polling questions 1705, which when submitted delivers the data 1701 back to the database 1702 on the server 102.

Juror Polling

Designation of Polling Question by Attorney

Attorneys will have the option of choosing pre-set generic polling questions (see Appendix B) as to juror reaction to each case argument, as well as general verdict questions.

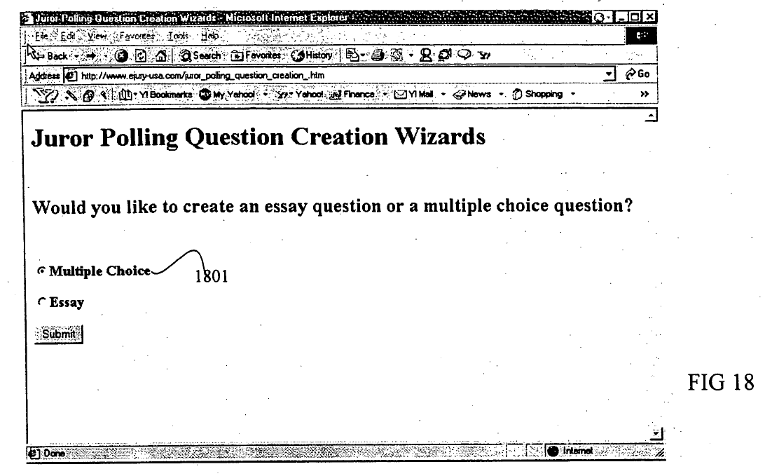

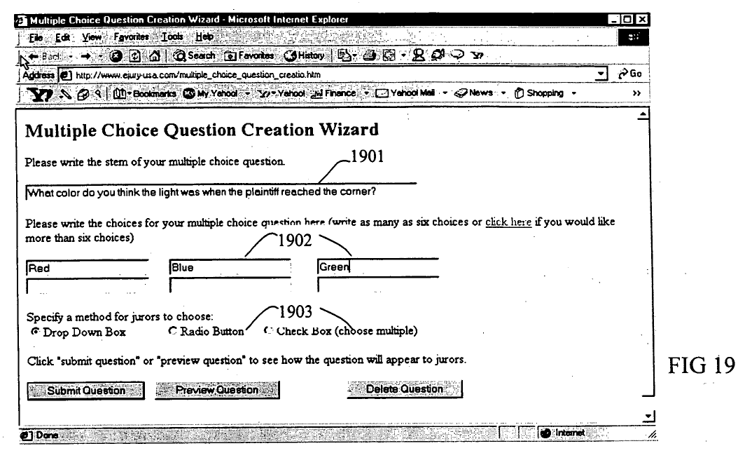

Attorneys also have the option of creating their own polling questions, including open-ended essay questions and more specific multiple choice questions, e.g., What color do you think the light was when Junior got to the intersection?: a Red b Yellow c Green. A specialized question creation sequence is available for this purpose, as shown in FIGS. 18, 19 and 20. Attorneys first select whether to create a multiple choice or essay question 1801. If attorneys choose “multiple choice,” they will be linked to a multiple choice question creation page, as seen in FIG. 19. There they will be asked to write in the question stem—or text of the question 1901. They are also prompted to specify the multiple choices the juror may choose from 1902 and the graphical format with which questions will be presented, e.g., drop-down box/radio buttons, etc. 1903. If attorneys choose essay, they simply have to enter the text of their essay question 2001 and the permissible length of the juror's answer 2002. Upon completion of the drafting of questions in this manner, the questions are stored on the site servers to await distribution to jurors after their viewing of case presentations.

Response to Polling Questions by Jurors

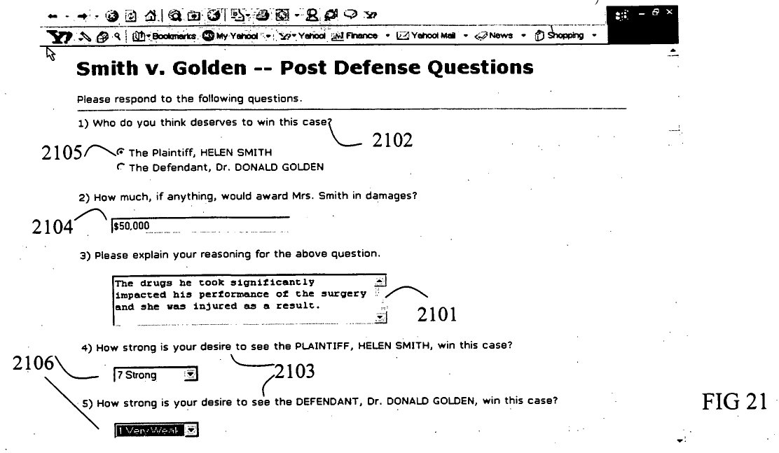

At the end of the streaming media presentation of each argument, the viewer's computer is automatically linked from the media presentation to the URL of the post-presentation questionnaire, which is stored on the main server 102, as seen in FIG. 21. Jurors type in answers to the open-ended essay type questions 2101 and also respond to the closed-ended multiple choice questions about verdict preference e.g. “Who do you think deserves to win this case? Plaintiff or Defendant 2102, strength of opinion 2103, damages 2104 and/or case-related opinions or other case issues (e.g. “Do you think Frank was misinformed by the car dealership before he signed the sales contract?” Yes/Not sure/No).

Jurors select answers to multiple choice questions by using their computer hardware mouse and keyboard to select screen items e.g. radio buttons 2104, check boxes (not depicted), or drop-down lists 2106 corresponding to their answer. Upon submission of this information by clicking the “submit answers” button on the questionnaire, the answers are sent to the site server for storage and subsequent analysis.

Daily Status Updates to Attorneys and Client-Viewers

Each day the server database is automatically queried to determine the number of jurors who have listened to the attorney's case and have answered the polling questions. The server automatically e-mails the attorney and any client-viewers each day to notify them of the number of jurors who have responded to date.

Delivery of Polling Results to Client-Viewers and Lawyers.

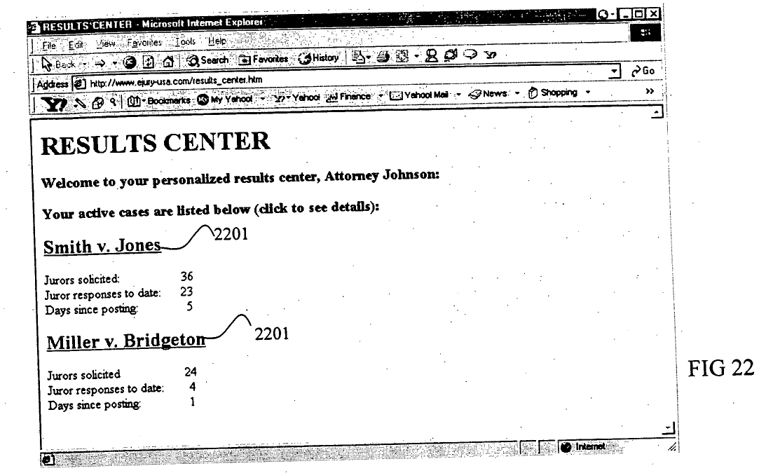

At their leisure or upon learning that a sufficient number of jurors have responded to the polling questions, attorneys and/or client/viewers will log on to the service home page and click a link to the “results center,” which will be accessible only through entering his identification number and password. Once the authorization information is confirmed through cross-checking with the database on the server, a personalized results page as seen in FIG. 22 will then come up with a listing of cases 2201 he has active and/or is authorized to view as a client-viewer.

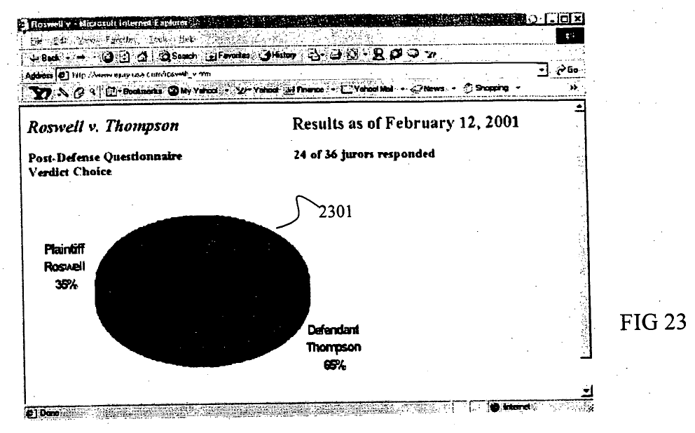

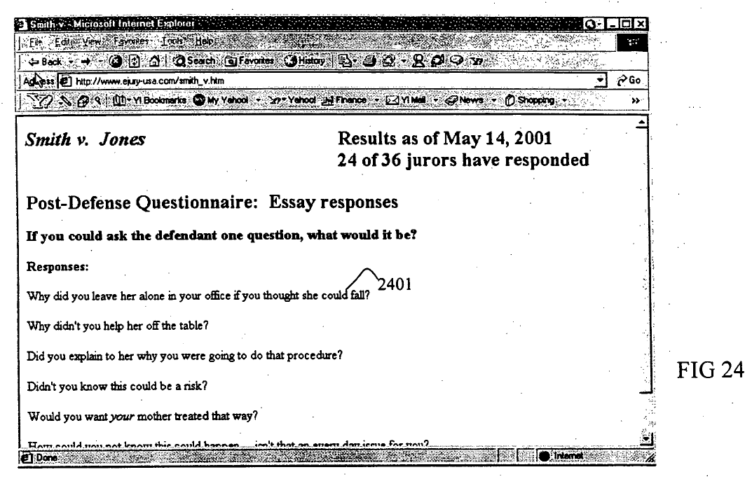

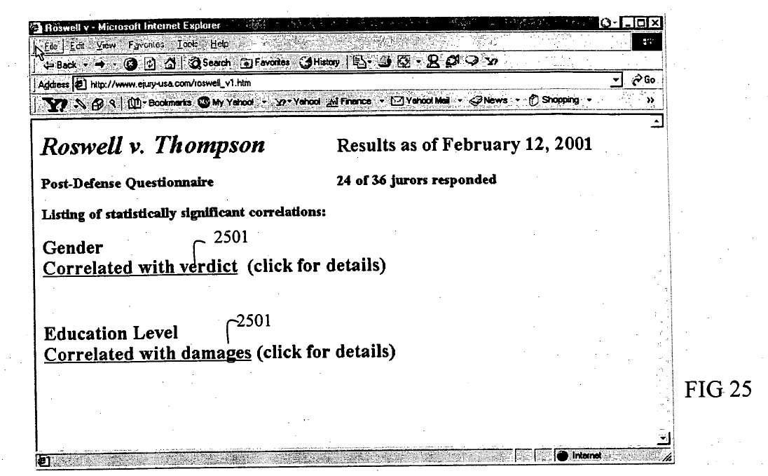

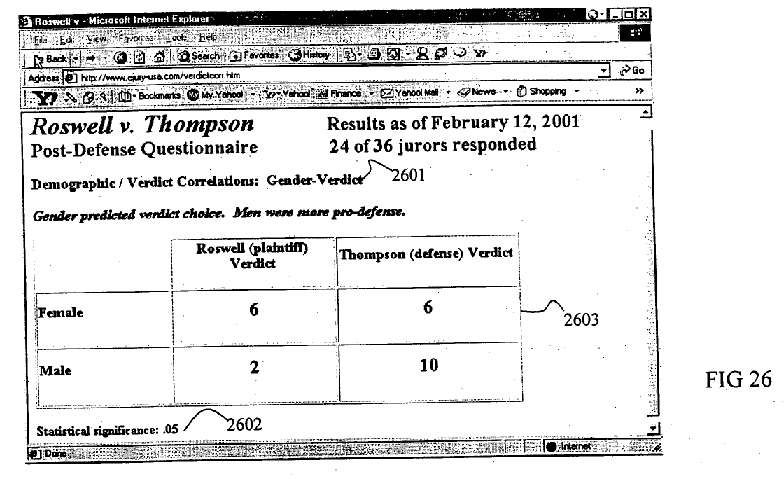

He then clicks on a case listing he is interested in. The system then generates a web page of charts/graphs of choice frequencies 2301 for multiple choice questions as in FIG. 23, listings of essay question responses 2401 as in FIG. 24, as well as a listing of demographic factors (FIG. 25) for which significant response correlations have been found through a statistical computation at the server. Attorneys/client-viewers may then click on any one of these listed variable correlations 2501 to obtain a more detailed view (FIG. 26) of the nature 2601 and significance 2602 of the correlation, as well as a breakdown of the raw numbers 2603, where appropriate. Attorneys may use this information in making decisions about jury selection or trial strategy/juror communication decisions.

Attorneys have the option of printing these graphs, modifying them e.g. from bar to pie or e-mailing them to associates or partners.

Juror Payment

Juror payment occurs automatically upon completion of questionnaire items for the case. Jurors are paid through automatic transfer of funds to bank accounts or through electronic payment technology partners.

Client-Viewer Billing

Lawyers are billed according to the length of their arguments, the number of exhibits, the nature and length of their questionnaires, the number of jurors requested, the specificity of jurors requested and the speed of turnaround requested.

Payments from lawyers are made through registered credit cards or to a purchase order or account set-up by the lawyer's firm.

Alternative Uses and Methodologies

In addition to the case testing usage contemplated above, this invention may also be used by attorneys to actually resolve cases. Attorneys may agree ahead of time to present their most powerful evidence to jurors through the tools detailed here. They may agree to resolve their case in accordance with the verdicts or majority of verdicts rendered by the online jurors.

Instead of case presentation development being done through the main server or the vendor's server, attorneys may also create their own streaming media file using software and microphones and equipment on their own computer. The service would also permit this file to be transferred to the server 102 or 122 directly, without going through the telephone input process. Attorneys who are more technologically adept or equipped may choose this method as a way to more closely tailor the nature of the media presentation they provide.

As available bandwidths grow, this service may include the presentation of live or recorded motion video of attorneys speaking their cases. In that iteration of the invention, attorneys may speak their arguments into a camera and microphone in their offices, rather than over the telephone method. The telephone method may remain the easiest method for attorneys who do not feel comfortable or interested in utilizing more complex computer technology.

Another application of this service is to test things other than legal arguments in legal cases. The availability of a pool of lay jurors, who may also be viewed as “consumers” may stir the interest of those selling ideas, concepts or products in other contexts, such as marketers or public policy analysts, political polling services, etc. the system may be useful in any context in which a party wishes to gauge the persuasiveness of a position by presenting a performance to a set of individuals and getting their feedback.

Another application in a legal context is for attorneys to test the impact of modification of single case facts or the introduction or exclusion of particular pieces of evidence. Given the easy availability of a large pool of jurors in the system database, attorneys may choose to test one argument with a piece of evidence included and another with it excluded to see if it makes a difference in the verdicts chosen by jurors. Another application would be to test the differential efficacy of the same argument with jurors in different venues.

Another use of this would be to test the argument on entirely different demographic groups. For example, the attorney may want to test the argument on 20 individuals with only high school education and then to compare it to how effective it is with individuals with graduate school educations. This type of information may be used make jury selection decisions, as well as educating the attorney about what issues jurors of different groupings understand and do not understand.

Another possible utilization will employ the telephone as a feedback mechanism for lawyers as well. In this methodology, jurors who have heard the case arguments will then dial into a telephone conference for a conference-call like debate of the issues and feedback session with jurors. This type of voice to voice interchange between jurors may also be made available online, without telephones but with computer microphones.

Another modality involves utilizing online text-based chat room functionality for having discussions between jurors about the case. This method may be either moderated or not moderated. This provides lawyers the opportunity to hear more in vivo reaction to them and their case than in afforded by survey data alone.

Another mode of attorney submission of case presentations is for them to send a videotape that they have created with their own video camera. This recording may be converted by staff at the service into a streaming media presentation and then delivered to jurors on the service.

Other implementations are also within the scope of the following claims.

### APPENDIX A

Full list of Juror Information Questions

Name
Gender
Age
Race optional
Occupation
Education
Income bracket optional
Registered Voter?
Driver's License # for identity confirmation
Address
Telephone number
County of residence
U.S. Citizen?
Ever a plaintiff or defendant in a lawsuit
Ever a juror?
   What type of case?
Ever charged with a crime.
Immediate family member ever sued?
Speed of Internet connection.
   Full List of Attorney Information Questions
Name
Name of firm.
Address
Age
States licensed in.
How many years licensed in each state.
Number of trials per year.
Number of mediations per year.
Number of arbitrations per year.
Category of litigation.
Primarily plaintiff or defense representation.
LEVEL OF FAMILIARITY WITH INTERNET
Level of familiarity with presentation software e.g. Powerpoint
Level of familiarity with graphics files e.g. jpg; .bmp

[image]

[image]

[image]

1. A method comprising
enabling electronic posting of a performance that expresses a position of a party on an issue,
storing the posted performance digitally,
enabling at least two different individuals at two different locations to observe at least portions of the performance, and
enabling each of the individuals to post electronically feedback relating to the persuasiveness of the performance of the party with respect to the issue.

2. The method of claim 1 in which the position on the issue comprises a legal argument related to a litigation issue.

3. The method of claim 1 in which the performance includes audio material.

4. The method of claim 1 in which the performance includes graphical material.

5. The method of claim 1 in which at least part of the performance is posted from a telephone.

6. The method of claim 1 in which the two different individuals observe the performance at two different times.

7. The method of claim 1 in which the performance is delivered as streaming digital information to the individuals.

8. The method of claim 1 in which the feedback is posted in the form of email or responses given through a website.

9. The method of claim 1 in which the electronic posting of the performance includes uploading graphical information.

10. The method of claim 1 in which the electronic posting of the performance includes posting of timing information useful in synchronizing audio material and graphical material.

11. The method of claim 1 also including analyzing the feedback from the individuals.

12. The method of claim 1 in which the individuals comprise jurors.

13. The method of claim 1 also including
enabling the designation of groups from which the individuals are to be drawn.

14. A method comprising receiving by telephone, a spoken legal argument, storing the argument as a digital file, making the argument available electronically to users at different locations as streaming media for performance to the users, and receiving feedback from individuals at different locations with respect to the persuasiveness of the argument.

15. A method comprising
enabling electronic posting from a telephone of a performance that expresses a legal argument of a party on a litigation issue, the performance including at least an audio presentation and graphic material,
storing the posted performance digitally,
enabling at least two different individuals at two different locations to observe at least portions of the performance at two different times, the performance being observed in the form of streaming digital information,
enabling each of the individuals to post, by email or through a website, feedback relating to the persuasiveness of the performance of the party with respect to the issue, and
analyzing the feedback from the jurors.
